(19) United States
(12) Patent Application Publication
(10) Pub. No.: US 2026/0054661 A1
(43) Pub. Date: Feb. 26, 2026

(54) PLATE WITH ACOUSTIC BLACK HOLES

(71) Applicant: GM Global Technology Operations LLC, Detroit, MI (US)

(72) Inventors: Song He, Troy, MI (US); Yilun Luo, Ann Arbor, MI (US); Lu Huang, Troy, MI (US); Hui-ping Wang, Troy, MI (US)

(21) Appl. No.: 18/813,303

(22) Filed: Aug. 23, 2024

(51) Int. Cl. B60R 13/08; H02M 7/00

(52) U.S. Cl. CPC B60R 13/0884; H02M 7/003

(57) ABSTRACT

An integrated power electronics (IPE) module is provided. The IPE module includes an IPE casing including at least one panel and a power inverter module (PIM) carrying the IPE casing. The PIM is housed within an internal chamber. The panel includes an acoustic black hole plate having an acoustic black hole zone including at least one acoustic black hole. Each acoustic black hole includes a geometric center and a damper. The acoustic black hole plate has a decreasing acoustic black hole plate thickness from an outer edge of the acoustic black hole to the geometric center, and the decreasing acoustic black hole plate thickness traps vibration energy for efficiency attenuation. The damper is coupled to the acoustic black hole plate and is located at the geometric center.

### INTRODUCTION

The present disclosure relates to an integrated power electronics (IPE) module, and more particularly, to an integrated power electronics (IPE) module having an acoustic black hole plate with acoustic black holes.

Hybrid vehicles and electric vehicles increasingly utilize integrated power electronics (IPE) modules, which may generally include a power inverter module integrated (i.e., packaged) with one or more components, for example inverters, motors, generators, pumps, clutches, and other components.

While prior art methods and systems attempt to minimize and prevent noise and vibrations within a vehicle and may achieve their particular purpose, a need still exists for a new and improved noise and vibration reduction solution. Accordingly, an improved IPE module is needed.

### SUMMARY

According to several aspects of the present disclosure, an integrated power electronics (IPE) module is provided. The IPE module includes an IPE casing including at least one panel and a power inverter module (PIM) carrying the IPE casing. The IPE casing defines an internal chamber, and the PIM is housed within the internal chamber. The at least one panel includes an acoustic black hole plate having an acoustic black hole zone including at least one acoustic black hole. Each acoustic black hole targets panel resonant hot spots and contributes to noise, vibration, and harshness (NVH) performance. Each acoustic black hole includes a geometric center and a damper. The acoustic black hole plate has a decreasing acoustic black hole plate thickness from an outer edge of the acoustic black hole to the geometric center, and the decreasing acoustic black hole plate thickness traps vibration energy for efficiency attenuation. The damper is coupled to the acoustic black hole plate and is located at the geometric center.

In accordance with another aspect of the disclosure, the IPE module includes an aluminum panel.

In accordance with another aspect of the disclosure, the IPE module includes at least one acoustic black hole that is at least one of circular or elliptical.

In accordance with another aspect of the disclosure, the IPE module includes at least one acoustic black hole that is a machined acoustic black hole.

In accordance with another aspect of the disclosure, the IPE module includes at least one acoustic black hole that is a stamped acoustic black hole.

In accordance with another aspect of the disclosure, the IPE module includes an acoustic black hole zone that includes a 2×2 acoustic black hole array.

In accordance with another aspect of the disclosure, the IPE module includes a decreasing acoustic black hole plate thickness having a power law tapered profile.

In accordance with another aspect of the disclosure, the IPE module includes a decreasing acoustic black hole plate thickness extending from a first surface to a second surface of the acoustic black hole plate.

In accordance with another aspect of the disclosure, the IPE module includes a damper formed of a single material.

In accordance with another aspect of the disclosure, the IPE module includes a multi-layer damper.

According to several aspects of the present disclosure, an acoustic black hole plate for use with an integrated power electronics (IPE) module is provided. The acoustic black hole plate includes at least one acoustic black hole for targeting panel resonant hot spots and contributes to noise, vibration, and harshness (NVH) performance. Each acoustic black hole includes a geometric center and a damper located at the geometric center. The acoustic black hole plate has a decreasing acoustic black hole plate thickness from an outer edge of the acoustic black hole to the geometric center. The decreasing acoustic black hole plate thickness traps vibration energy for efficiency attenuation.

In accordance with another aspect of the disclosure, the acoustic black hole plate includes at least one acoustic black hole that is at least one of circular or elliptical.

In accordance with another aspect of the disclosure, the acoustic black hole plate includes at least one acoustic black hole that is a machined acoustic black hole.

In accordance with another aspect of the disclosure, the acoustic black hole plate includes at least one acoustic black hole that is a stamped acoustic black hole.

In accordance with another aspect of the disclosure, the acoustic black hole plate includes a 2×2 acoustic black hole array.

In accordance with another aspect of the disclosure, the acoustic black hole plate includes a decreasing acoustic black hole plate thickness having a power law tapered profile.

In accordance with another aspect of the disclosure, the acoustic black hole plate includes a decreasing acoustic black hole plate thickness extending from a first surface to a second surface of the acoustic black hole plate.

In accordance with another aspect of the disclosure, the acoustic black hole plate includes a damper formed of a single material.

In accordance with another aspect of the disclosure, the acoustic black hole plate includes a damper that is a multi-layer damper.

According to several aspects of the present disclosure, an integrated power electronics (IPE) module is provided. The integrated power electronics (IPE) module includes an IPE casing including at least one panel and a power inverter module (PIM) carried by the IPE casing. The IPE casing defines an internal chamber, and the PIM is housed within the internal chamber. The at least one panel includes an acoustic black hole plate formed of aluminum, and the acoustic black hole plate has an acoustic black hole zone including a 2×2 acoustic black hole array. Each acoustic black hole targets panel resonant hot spots and contributes to noise, vibration, and harshness (NVH) performance. Each acoustic black hole includes a geometric center and a multi-layer damper located at the geometric center. The acoustic black hole plate has a decreasing acoustic black hole plate thickness having a power law profile, and the decreased acoustic black hole plate thickness extends from an outer edge of the acoustic black hole to the geometric center. The decreasing acoustic black hole plate thickness traps vibration energy for efficiency attenuation. The multi-layer damper includes at least a first layer of aluminum and another layer of rubber.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having an integrated power electronics (IPE) or inverter module having a damper panel configured to improve noise, vibration, and harshness (NVH) performance, in accordance with the present disclosure.

FIG. 2 is a perspective view illustrating an example of the integrated power electronics (IPE) module or inverter module shown in FIG. 1, where the IPE module or inverter module includes an integrated acoustic black hole plate with multiple acoustic black holes, in accordance with the present disclosure.

FIG. 3 is a side cross section view illustrating a portion of the acoustic black hole plate shown in FIG. 2, where the acoustic black hole plate has a machined acoustic black hole and a damper, in accordance with the present disclosure.

FIG. 4 is a perspective view illustrating an acoustic black hole plate with an array of stamped acoustic black holes, in accordance with the present disclosure.

FIG. 5 is a side cross section view illustrating a portion of the acoustic black hole plate shown in FIG. 2, where the acoustic black hole plate has a stamped acoustic black hole and a damper molded in a concave side of the acoustic black hole, in accordance with the present disclosure.

FIG. 6 is a perspective view illustrating the damper shown in FIGS. 3 and 5, where the damper is a multi-layer damper, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

In many electric vehicles, inverter and IPE resonances may dominate electric drive unit noise. Power inverter modules and vehicle components, for example the motors, generators, pumps, and clutches, are known to cause noise and/or vibrations, which operators of a vehicle with the IPE modules may find undesirable. Some damp patch solutions may be effective for controlling resonances and reducing noise radiation, but extra packaging may increase mass and cost. Additionally, aluminum housing with steel dampers may lead to significant corrosion. Damping treatment of IPE modules (such as patches with steel plates) can cause galvanic corrosion issues over time and causes safety concerns.

A high-damping and light-weight panel is disclosed herein that uses acoustic black holes (ABH) for inverter and integrated power electronics (IPE) applications. Multiple three-dimensional (3D) ABH features are used to target panel resonant hotspots and improve noise, vibration, and harshness (NVH) performance. Inside each ABH zone is at least one acoustic black hole, where material is removed from the panel by machining or expelled by stamping or incremental forming to provide decreasing panel thickness (e.g., exponential decay) toward its geometric center. This continuous decrease of structural stiffness focuses vibration energy toward an ABH geometric center, where a small amount of damping material is located to efficiently absorb the vibration energy. Additionally, the integrated power electronics (IPE) module and dampening panel described herein reduces an amount of damping material required (as much as 90%) and reduces overall mass of the inverter cover (as much as 20%).

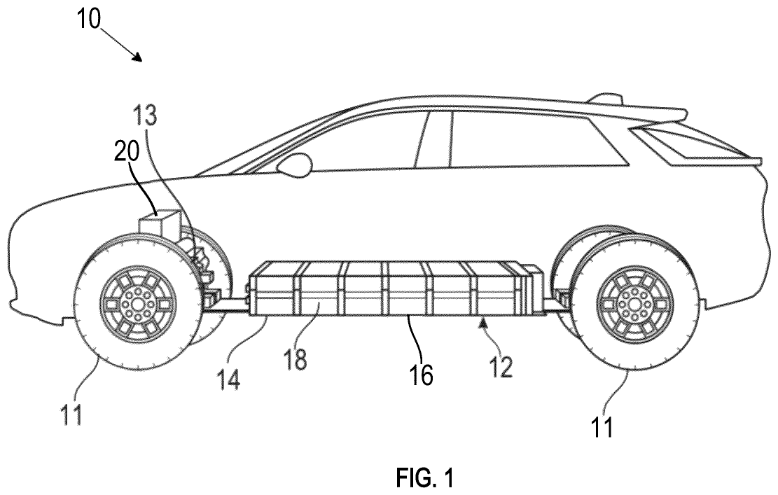

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 13. The electric motors/inverters receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 16 for supporting a plurality of battery cells 18. In an example, the battery pack 12 may have fifty or more battery cells 18. Additionally, at least one integrated power electronics (IPE) module 20 or an inverter module is electrically and/or mechanically coupled to the at least one electric motor 13.

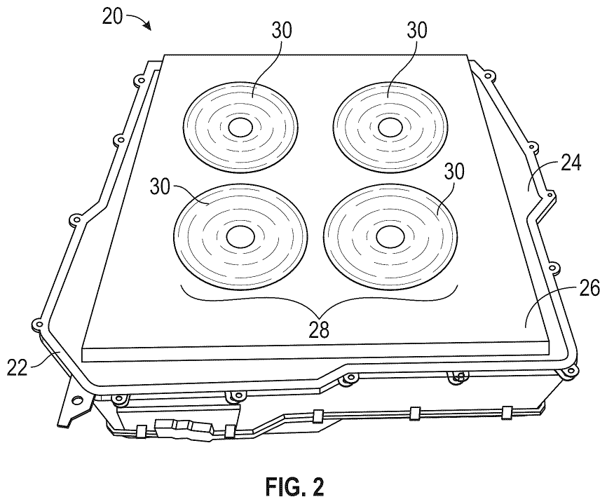

FIG. 2 illustrates a perspective view of the integrated power electronics (IPE) module 20 (or inverter module 20) shown in FIG. 1. The IPE module 20 is a specialized component in electronics designed to regulate and control electrical current within a system (e.g., an electric system in vehicle 10). An inverter module 20 is a power electronic device that converts direct current (DC) into alternating current (AC). The IPE module 20 includes an IPE casing 22 and a power inverter module (PIM) (not shown). The IPE casing 22 is configured to enclose and/or house an interior of the IPE module 20 from contaminants and its environment. The IPE casing 22 includes at least one panel 24, including an acoustic black hole plate 26. The acoustic black hole plate 26 may be at least one of the panels 24 and is integral with the casing 22. The at least one panel 24 may be formed from a variety of materials suitable for providing structural strength and environmental protection for components within the IPE casing 22. In one example, the IPE casing 22 and the acoustic black hole plate 26 are formed of aluminum.

As shown in FIG. 2, the acoustic black hole plate 26 is part of and integral with the IPE casing 22. The acoustic black hole plate 26 has an acoustic black hole zone 28, which further includes at least one acoustic black hole (ABH) 30. The acoustic black hole zone 28 shown in FIG. 2 includes a 2×2 array of acoustic black holes 30, although it will be appreciated that acoustic black hole zone 28 may include array(s) with different numbers, sizes and configurations of acoustic black holes 30. Each acoustic black hole 30 is configured to target hot spots of panel resonant and contribute to noise, vibration, and harshness (NVH) improvement. In examples, each acoustic black hole 30 may have a circular configuration, an elliptical configuration, other configurations, and/or combinations thereof. In the example shown in FIG. 2, each acoustic black hole 30 in the acoustic black hole zone 28 has a circular configuration. In example shown in FIG. 2, each acoustic black hole 30 has the same size, and they have different size and positions, depending on the hotspot locations on the acoustic black hole panel 26.

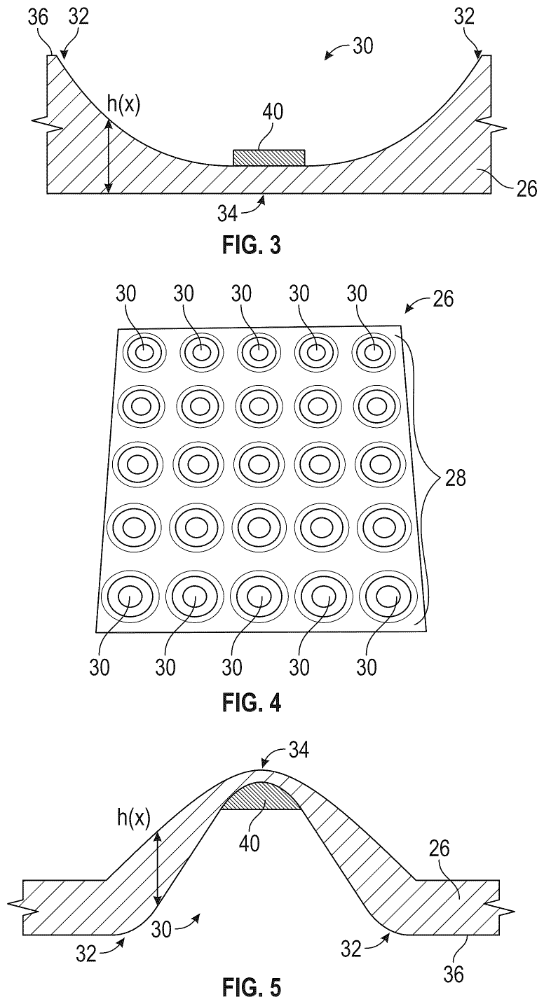

FIG. 3 illustrates a cross-section view of an acoustic black hole 30. In an acoustic black hole, phonons (i.e., sound perturbations, sound waves) become trapped within a region of fluid flowing faster than the local speed of sound. Each acoustic black hole 30 is used for passive vibration and control of the phonons in the IPE module 20. Bending sound waves in an IPE casing 22 and/or the acoustic black hole plate 26 have a propagation velocity c with a function of elastic modulus E, thickness h, density ρ, Poisson's ratio v, and frequency ω, as shown in the following equation.

$$c = {( \frac{E {h}^{2}}{12 ρ ( 1 - {v}^{2} )} )}^{1 / 4} \sqrt{ω}$$

Each acoustic black hole (ABH) 30 has a decreasing acoustic black hole plate thickness h from an outer edge 32 of the acoustic black hole 30 to a geometric center 34 of the acoustic black hole 30. The decreasing dampening panel thickness h results in a continuous reduction of bending stiffness, which further leads to a reduction of propagation vibration velocities (c₂<c₁) and increased vibration amplitudes (A₂>A₁). Thus, the decreasing acoustic black hole plate thickness traps vibrational energy for efficiency attenuation.

The decreasing acoustic black hole plate thickness h may be optimized with various shapes of power-law tapered profiles with different values of m, where m is an exponent of the power-law profile. The exponent m may be controlled by a radius L_{ABH} of the acoustic black hole 30 as shown in the following equation, where h(x) is thickness of the acoustic black hole plate 26, x is distance from a tip of the power-law curve with residual thickness, and h₁ is residual thickness.

$$h ( x ) = \frac{( T - {h}_{1} ) {x}^{m}}{{L}_{A B H}^{m}} + h 1$$

In examples, the power-law exponent may include 2, 3, 4, and so forth, resulting in a variety of decay rates of the decreasing acoustic black hole plate thickness h from the outer edge 32 to the geometric center 34. To achieve the decreasing thickness, materials can be removed or formed from either one side or both sides of the acoustic black hole plate 26. In the example shown in FIG. 3, material is removed from the top surface of the acoustic black hole plate 26 to form the acoustic black hole 30.

In the example shown in FIG. 3, the acoustic black hole (ABH) 30 has a machined configuration. In this instance, the acoustic black hole 30 may be formed by removing, using a machining process, a portion of the acoustic black hole plate 26 from a first surface 36 in the form of the acoustic black hole 30. In the example shown in FIG. 3, one side (e.g., an unmachined surface) of the acoustic black hole plate 26 is planar. The removed portion of the acoustic black hole plate 26 has a decreasing acoustic black hole plate thickness h within the acoustic black hole 30 as described above.

FIG. 4 is a perspective view illustrating an acoustic black hole plate 26 having an acoustic black hole zone 28 with a plurality of acoustic black holes 30 in a stamped configuration. In this example, the acoustic black hole zone 28 includes a 5×5 array of acoustic black holes 30. The ABH array in FIG. 5 is evenly distributed with same size acoustic black holes 30. In other examples, the acoustic black hole 30 array can have un-even distribution and different sizes to target the hot spots where high vibration energy is identified.

FIG. 5 is a cross-section view of one stamped-configuration acoustic black hole 30 in the acoustic black hole plate 26 shown in FIG. 4. Metal stamping (or forming) each acoustic black hole 30 includes a cold-forming process that uses dies and presses to bend and form each acoustic black hole 30 in the acoustic black hole plate 26. In this stamped configuration, the acoustic black hole 30 has an exponentially decreasing acoustic black hole plate thickness h from an outer edge 32 of the acoustic black hole 30 to a geometric center 34 as determined using the above equations. In the stamped configuration and within the acoustic black hole 30, neither the first surface 36 nor the second surface 38 of the acoustic black hole plate 26 are parallel, as shown in FIG. 5. In other examples, the decreasing panel thickness h is not exponentially decreasing.

Referring to FIGS. 3 and 5, each acoustic black hole 30 includes a damper 40 coupled to the acoustic black hole plate 26 and located at the geometric center 34. At the bottom of each acoustic black hole 30, which is at the geometric center 34 where the acoustic black hole plate 26 has a minimum thickness, maximum vibration energy is trapped and can be effectively attenuated by the damper 40 by converting vibrational energy into heat. Each damper 40 can be coupled to the damper 40 using an adhesive, for example a cold pressure adhesive, or using a molding process. The damper 40 may include a constraint layer damper (e.g., a single material) or a multi-layer damper.

In the examples shown in FIGS. 3 and 5, the damper 40 is depicted as a single layer or single material damper 40 formed of a material suitable for damping sound, isolating vibration, and absorbing shock. Some examples of a suitable material include synthetic viscoelastic urethane polymer, stainless steel, aluminum, cotton, acoustic foam, open-cell insulation, rubber, and the like. In one specific example, the damper 40 includes nitrile rubber. In another specific example, the damper 40 includes aluminum. It will be appreciated that the single layer or single material damper 40 may include other suitable materials not listed herein.

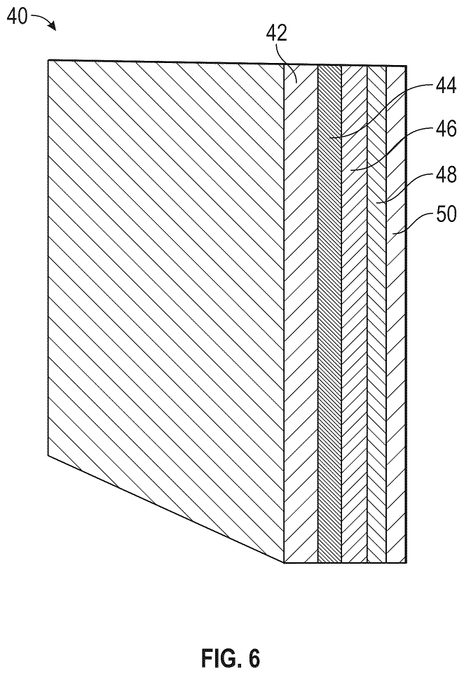

FIG. 6 illustrates a multi-layer damper 40 that is similarly formed of a material suitable for damping sound, isolating vibration, and absorbing shock. The multi-layer damper 40 may be used in both acoustic black hole 30 examples illustrated in FIGS. 3 and 5 as well as other configurations of acoustic black holes. A multi-layer design uses materials with different impedance to reflect vibration energy by a high impedance layer back to the high damping layer, which improves vibration energy absolution. Some examples of suitable materials include synthetic viscoelastic urethane polymer, stainless steel, aluminum, cotton, acoustic foam, open-cell insulation, rubber, and the like. In a specific example, a multi-layer damper 40 includes a first layer 42 of aluminum, a second layer 44 of a viscoelastic bonding material, a third layer 46 of aluminum, a fourth layer 48 of nitrile rubber, and a fifth layer 50 of adhesive. It will be appreciated that the multi-layer damper 40 may include other materials and numbers of layers.

The acoustic black hole plate 26 and IPE module 20 of the present disclosure is advantageous and beneficial over prior art solutions. An IPE module that includes an acoustic black hole zone 28 and at least one acoustic black hole 30 reduce IPE module and acoustic black hole plate 26 mass, which also improves NVH performance. Additionally, using an acoustic black hole 30 with a continuously decreasing damper panel thickness h traps vibration energy for efficient attenuation with a smaller than normal damper 40. The acoustic black hole 30 location, size, and shape can be optimized to target panel resonances for varying inverter and IPE module designs. Machining, stamping, incremental forming, or a combination may be used to remove material from each acoustic black hole 30. Such a process reduces baseline acoustic black hole plate 26 mass rather than adding mass as compared with conventional damping strategies, which additional damping patches are attached to the baseline panel. Further, the damper 40 used herein may include constraint layer damping or a multi-layer damper 40.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An integrated power electronics (IPE) module in a vehicle, the IPE module comprising:
an IPE casing including at least one panel;
a power inverter module (PIM) carrying the IPE casing, the IPE casing defining an internal chamber, wherein the PIM is housed within the internal chamber; and
the at least one panel including an acoustic black hole plate, the acoustic black hole plate having an acoustic black hole zone including at least one acoustic black hole, wherein each acoustic black hole targets panel resonant hot spots and contributes to noise, vibration, and harshness (NVH) performance, wherein each acoustic black hole includes
a geometric center, wherein the acoustic black hole plate has a decreasing acoustic black hole plate thickness from an outer edge of the acoustic black hole to the geometric center, wherein the decreasing acoustic black hole plate thickness traps vibration energy for efficiency attenuation; and
a damper coupled to the acoustic black hole plate and located at the geometric center.

2. The integrated power electronics (IPE) module of claim 1, wherein the panel is aluminum.

3. The integrated power electronics (IPE) module of claim 1, wherein at least one acoustic black hole is at least one of circular or elliptical.

4. The integrated power electronics (IPE) module of claim 1, wherein at least one acoustic black hole is a machined acoustic black hole.

5. The integrated power electronics (IPE) module of claim 1, wherein at least one acoustic black hole is a stamped acoustic black hole.

6. The integrated power electronics (IPE) module of claim 1, wherein the acoustic black hole zone includes a 2×2 acoustic black hole array.

7. The integrated power electronics (IPE) module of claim 1, wherein the decreasing acoustic black hole plate thickness has a power law tapered profile.

8. The integrated power electronics (IPE) module of claim 1, wherein the decreasing acoustic black hole plate thickness extends from a first surface to a second surface of the acoustic black hole plate.

9. The integrated power electronics (IPE) module of claim 1, wherein the damper is a single material.

10. The integrated power electronics (IPE) module of claim 1, wherein the damper is a multi-layer damper.

11. An acoustic black hole plate for use with an integrated power electronics (IPE) module, comprising:
at least one acoustic black hole for targeting panel resonant hot spots and contributes to noise, vibration, and harshness (NVH) performance, each acoustic black hole including
a geometric center, wherein the acoustic black hole plate has a decreasing acoustic black hole plate thickness from an outer edge of the acoustic black hole to the geometric center, wherein the decreasing acoustic black hole plate thickness traps vibration energy for efficiency attenuation; and
a damper located at the geometric center.

12. The acoustic black hole plate of claim 11, wherein at least one acoustic black hole is at least one of circular or elliptical.

13. The acoustic black hole plate of claim 11, wherein at least one acoustic black hole is a machined acoustic black hole.

14. The acoustic black hole plate of claim 11, wherein at least one acoustic black hole is a stamped acoustic black hole.

15. The acoustic black hole plate of claim 11, wherein the at least one acoustic black hole includes a 2×2 acoustic black hole array.

16. The acoustic black hole plate of claim 11, wherein the decreasing acoustic black hole plate thickness has a power law tapered profile.

17. The acoustic black hole plate of claim 11, wherein the decreasing acoustic black hole plate thickness extends from a first surface to a second surface of the acoustic black hole plate.

18. The acoustic black hole plate of claim 11, wherein the damper is a single material.

19. The acoustic black hole plate of claim 11, wherein the damper is a multi-layer damper.

20. An integrated power electronics (IPE) module, the IPE module comprising:
an IPE casing including at least one panel;
a power inverter module (PIM) carried by the IPE casing, the IPE casing defining an internal chamber, wherein the PIM is housed within the internal chamber; and
the at least one panel including an acoustic black hole plate formed of aluminum, the acoustic black hole plate having an acoustic black hole zone including a 2×2 acoustic black hole array, wherein each acoustic black hole targets panel resonant hot spots and contributes to noise, vibration, and harshness (NVH) performance, and wherein each acoustic black hole includes
a geometric center, wherein the acoustic black hole plate has a decreasing acoustic black hole plate thickness having a power law profile, the decreased acoustic black hole plate thickness extending from an outer edge of the acoustic black hole to the geometric center, wherein the decreasing acoustic black hole plate thickness traps vibration energy for efficiency attenuation; and
a multi-layer damper located at the geometric center, wherein the multi-layer damper includes at least a first layer of aluminum and another layer of rubber.
